(19) United States
(12) Patent Application Publication
(10) Pub. No.: US 2004/0205496 A1
(43) Pub. Date: Oct. 14, 2004

(54) Displaying subheadings and hyperlinks in a scrollable long document

(75) Inventors: Rabindranath Dutta, Austin, TX (US); Kamal Chandrakant Patel, Cedar Park, TX (US)

Correspondence Address: Marilyn Smith Dawkins, International Business Machines Corporation, Intellectual Property Law Dept., Internal Zip 4054, 11400 Burnet Road,, Austin, TX, 78758, US

(73) Assignee: International Business Machines Corporation, Armonk, NY (US)

(21) Appl. No.: 09/975,443

(22) Filed: Oct. 11, 2001

(51) Int. Cl. G06F 17/00

(52) U.S. Cl. 715/501.1; 715/513

(57) ABSTRACT

The system, method and program of the invention displays portions of a long document in a limited viewing area of a display on a client machine. As a Web browser retrieves a requested document from a server, the Web browser parses the document for tags identifying any headings, hyperlinks, images, or other document components. A portion of the document is displayed in conjunction with a scroll bar. In response to receiving a designated user action, such as a right mouse click within the scroll bar area, a list of the identified document components are displayed. In response to receiving a user selection of one of the document components within the list, another portion of the document containing the selected document component is displayed. The list is removed from the display when the other portion of the document is displayed in response to the user selection or if a user action outside of the list area is received.

### BACKGROUND OF THE INVENTION

1. Field of the Invention

The present invention relates to accessing, displaying, and viewing information over the Internet, and more specifically to displaying and viewing subheadings and hyperlinks in a long document in a Web browser in response to a user input action in a displayed scroll bar area associated with the long document.

2. Description of the Related Art

As computational devices continue to proliferate throughout the world, there also continues to be an increase in the use of networks connecting these devices. Computational devices include large mainframe computers, workstations, personal computers, laptops and other portable devices including wireless telephones, personal digital assistants, automobile-based computers, etc. Such portable computational devices are also referred to as “pervasive” devices. The term “computer” or “computational device”, as used herein, may refer to any of such device which contains a processor and some type of memory.

The computational networks may be connected in any type of network including the Internet, an intranet, a local area network (LAN) or a wide area network (WAN). The networks connecting computational devices may be “wired” networks, formed using lines such as copper wire or fiber optic cable, wireless networks employing earth and/or satellite-based wireless transmission links, or combinations of wired and wireless network portions. Many such networks may be organized using a client/server architecture, in which “server” computational devices manage resources, such as files, peripheral devices, or processing power, which may be requested by “client” computational devices. “Proxy servers” can act on behalf of other machines, such as either clients or servers.

A widely used network is the Internet. The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.). The information in various data files is formatted for presentation to a user by a standard page description language; for example, tagged markup languages such as Hypertext Markup Language (HTML), Wireless Markup Language (WML), Extensible Markup Language (XML), etc.

In addition to basic presentation formatting, tagged markup languages allow developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”.

A browser is a program capable of submitting a request for information identified by an identifier, such as, for example, a URL, receiving the requested information or page identified by the URL, and rendering the requested page on a display.

A long document is defined herein to be such a block of information, identified by a URL, that is longer than what can be displayed on a single viewable display area of a given device, and one in which a scroll bar is utilized to enable a user to view portions of the content not currently in view. A given document when viewed on a desktop computer having a nineteen inch display monitor may not be a “long document” since the whole document may be viewable. However, if that same document is viewed on a hand held device having a three inch viewable display area, that same document may be a “long document” as defined herein since the whole document may not be viewable during a single viewing instance on a particular display device without scrolling or paging up or down.

When browsing a long document in a Web browser, it is hard to go to a particular subheading within the content very quickly. A user may have to keep scrolling, paging up or down, or repeatedly clicking the left mouse button until the heading text is visible. This becomes particularly more inconvenient the greater the length of a long document. Sometimes, if a user clicks too fast, the relevant regions of the page may disappear. If a user clicks too slow, the user has to constantly keep on seeing unneeded page contents. This becomes time consuming and increases eye strain.

### SUMMARY OF THE INVENTION

It is therefore an object of the present invention to provide faster page scrolling to a desired section in a long document.

It is a further object of the invention to display a list of subheadings and hyperlinks found within a long document in response to a single user action, such as a right mouse click in the scroll bar.

It is a further object of the invention to display a portion of the long document containing a subheading in response to a selection of the subheading in the list.

The system, method and program of the invention provides faster page scrolling to a desired location in a long document, e.g., a Web document. The user is enabled to view a list of components of the displayed document by performing a single user action, such as a right mouse click in the scroll bar area. The list may include the headings and subheadings of the document; a list of hyperlinks contained within the document; image source descriptions, or other components of a Web document as identified in tags including headings. Preferably, the document is parsed when it is initially accessed or retrieved and rendered to a viewable display screen area. The document is parsed for any headings, subheadings, hyperlinks, image sources, and other document components. The results of the parsing (i.e., a list of the headings, hyperlinks, image descriptions, or other document components), are stored in a cache. Upon receipt of a single user action, such as a right mouse click in the scroll bar area, the list is displayed to the user. The list may be displayed in an order or layout reflective of the document as a whole. Alternatively, the list may be displayed in an alphabetical order for a viewer to more readily find the desired portion of the document by an identifiable name.

Upon a selection of a document component within the list, a portion of the full document containing the selected document component will be displayed in the viewable portion of the screen display. For example, upon a first type of user input for selecting a hyperlink from the list, the portion of the full document containing the selected hyperlink will be rendered in the viewable potion of the screen display. It should be noted that in a further embodiment, upon a second type of user input for selecting the hyperlink, the Web content at the URL of the hyperlink will be rendered. In yet other embodiments, the content of the URL can only be accessed from a selection of the hyperlink from the displayed document and not from the list.

Furthermore, in a preferred embodiment, a subsequent mouse click anywhere outside the list of components will redisplay the original document and cause the list to disappear from the screen.

As such, upon a predetermined type of user input, a list of the headings, hyperlinks, or other document components contained within a long document are displayed to a user. Upon a selection of a specific document component from the list, the portion of the long document containing the selected component is automatically displayed to the user thereby effectuating a faster and more direct page scrolling to a desired location in a long document.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates a block diagram of a network computing environment in which a preferred embodiment of the present invention may be implemented;

FIG. 2 illustrates a block diagram of a browser program in accordance with a preferred embodiment of the present invention;

FIG. 3 A illustrates a long document having headings, subheadings, and hyperlinks as would be utilized in a preferred embodiment of the invention;

FIG. 3B illustrates the long document of FIG. 3A built with Hypertext Markup Language (HTML);

FIG. 4 illustrates the rendering of the long document in conjunction with a scroll bar on a display as utilized in accordance with a preferred embodiment of the invention;

FIG. 5 illustrates a list of document components of the long document being displayed in response to a single user action within the scroll bar area in accordance with a preferred embodiment of the invention;

FIG. 6 illustrates displaying a portion of the long document which contains a selected component from the list of components in accordance with a preferred embodiment of the invention; and

FIG. 7 illustrates a process and program flow of parsing a document for the heading, subheadings and hyperlinks; rendering a list of the parsed portions in response to a single user action; and automatically scrolling to the desired portion of the document in response to a selection of a document component within the list indicating the desired portion in accordance with a preferred embodiment of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

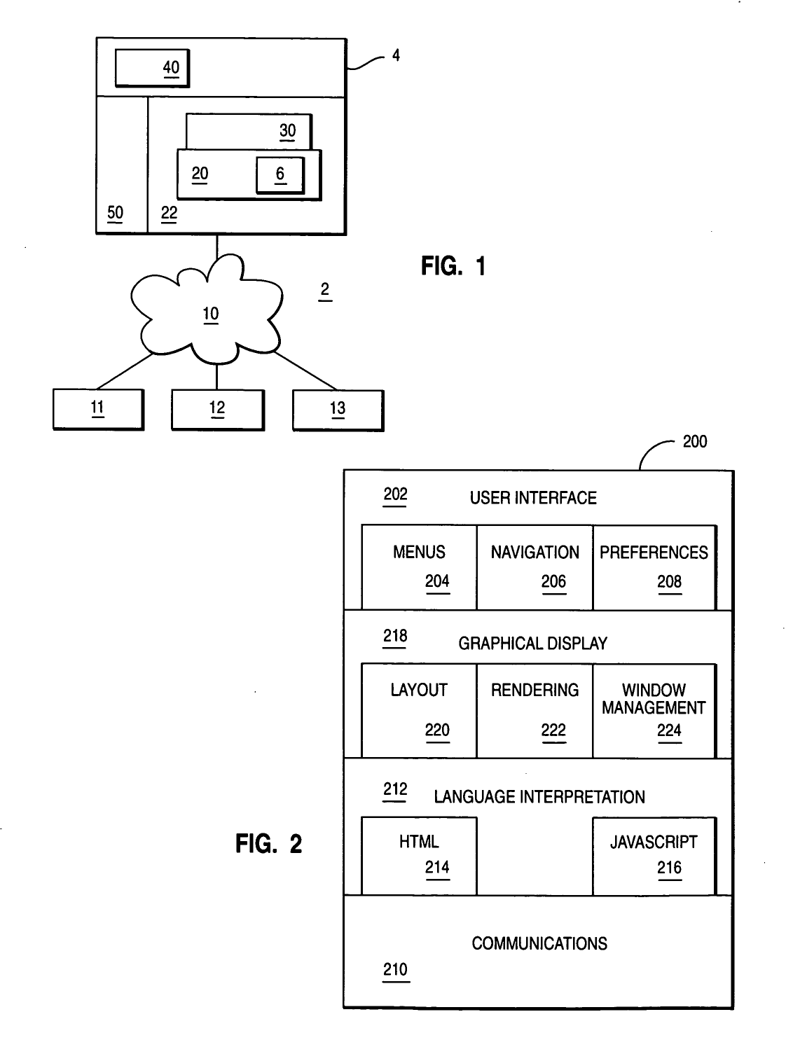

With reference to the Figures, and in particular with reference now to FIG. 1, a high-level block diagram of a network computing environment in which a preferred embodiment of the present invention may be implemented is depicted. The computing environment 2 includes at least one client computer 4 including a browser program or viewer program 6, such as the Microsoft Internet Explorer or Netscape Navigator, that is capable of retrieving files from servers 11, 12, 13 over a network 10. The client computer 4 may comprise any computer system known in the art capable of executing a browser program. The servers 11, 12, 13 may comprise any computer system known in the art capable of maintaining files and making such files accessible to remote computers. The terms “client” and “server” are used to refer to a computer's general role as a requester of data (the client) or provider of data (the server). In the Web environment, Web browsers such as Netscape Navigator typically reside on client systems and render Web documents (pages) served by server systems. Additionally, each of client systems and server systems may function as both a client and a server.

The browser 6 and servers 11, 12, 13 communicate using a document transfer protocol such as the Hypertext transfer Protocol (HTTP), or any other document transfer protocol known in the art, such as FTP, Gopher, WAIS, etc. The network 10 may be made up of a TCP/IP network, such as the Internet and World Wide Web, or any network system known in the art, e.g., LAN, Ethernet, WAN, System Area Network (SAN), Token Ring, etc.

The client computer 4 may be, but is not limited to, a personal computer, laptop, workstation, mainframe, or hand held computer including palmtops, personal digital assistant, smart phones, web enabled cellular phones, etc. The network environment 2 may also include a transcoder or proxy for transcoding Web documents from servers 11, 12, 13 into a form readable by client 4. Client computer 4 includes processor 40 and memory 50. Memory 50 includes volatile or nonvolatile storage and/or any combination thereof. Volatile memory may be any suitable volatile memory device, e.g., RAM, DRAM, SRAM, etc. Volatile memory is utilized in a preferred embodiment of the invention for caching the parsed document as a list of the subheadings and/or hyperlinks contained within the document. Nonvolatile memory may include storage space 22, e.g., via the use of hard disk drives, tapes, etc., for data, databases, and programs. The programs in memory include an operating system 30 and application programs 20 including a browser program 6. The browser program 6 displays a graphical user interface in which content from a file downloaded from one of the servers 11, 12, 13, such as a HTML page, is displayed. The browser GUI displays graphical buttons to perform operations related to the files downloaded from a server as further described herein.

The client computer 4 includes output devices (not shown) including a display for displaying the browser GUI and Web page and object content. The client computer also includes at least one input device (not shown) through which the user may enter input data to control the operation of the browser program 6, such as a keyboard, mouse, pen-stylus, touch sensitive screen, voice decoder for decoding voice commands, etc. In preferred embodiments, a user at the client computer 4 can input commands to control the browser program 6 through the graphical user interface (GUI) generated by the browser 6 or input device controls, such as keyboard keys, mouse buttons, touch pad regions, that are programmed to cause the browser to perform specific operations.

FIG. 2 is an exemplary block diagram of a browser program in accordance with a preferred embodiment of the present invention. A browser is an application used to navigate or view information or data in a network environment, such as the Internet or the World Wide Web. The browser may be a HTML browser, WML browser, or another type of browser for viewing various types of Web documents or transcoded Web documents.

In this example, browser 200 includes a user interface 202, which is a graphical user interface (GUI) that allows the user to interface or communicate with browser 200. This interface provides for selection of various functions through menus 204 and allows for navigation through navigation 206. For example, menu 204 may allow a user to perform various functions, such as saving a file, opening a new window, displaying a history, and entering a URL. Navigation 206 allows for a user to navigate various pages and to select Web sites for viewing. For example, navigation 206 may allow a user to see a previous page or a subsequent page relative to the present page. Preferences may be set through preferences 208.

Communications 210 is the mechanism with which browser 200 receives documents and other resources from a network such as the Internet. Further, communications 210 is used to send or upload documents and resources onto a network. In the depicted example, communications 210 uses HTTP. Other protocols may be used depending on the implementation. Documents that are received by browser 200 are processed by language interpretation 212, which includes an HTML unit 214 and a JavaScript unit 216. Language interpretation 212 will process a document for presentation on graphical display 218. In particular, HTML statements are processed by HTML unit 214 for presentation while JavaScript statements are processed by JavaScript unit 216. Other units may be included for processing various documents of other markup languages, e.g., a WML unit or a XML unit for processing Wireless Markup Language documents or Extensible Markup Language documents. The invention may be carried out using other presentation and file formats or alternate text markup languages than those described herein.

Graphical display 218 includes layout unit 220, rendering unit 222, and window management 224. These units are involved in presenting Web pages to a user based on results from language interpretation 212.

Browser 200 is presented as an example of a browser program in which the present invention may be embodied. Browser 200 is not meant to imply architectural limitations to the present invention. Presently available browsers may include additional functions not shown or may omit functions shown in browser 200. A browser may be any application that is used to search for and display content in a network environment. Browser 200 may be implemented using known browser applications, such as Netscape Navigator or Microsoft Internet Explorer. Netscape Navigator is available from Netscape Communications Corporation while Microsoft Internet Explorer is available from Microsoft Corporation.

The exemplary embodiments shown in FIGS. 1 and 2 are provided solely for the purposes of explaining the preferred embodiments of the invention; and those skilled in the art will recognize that numerous variations are possible, both in form and function.

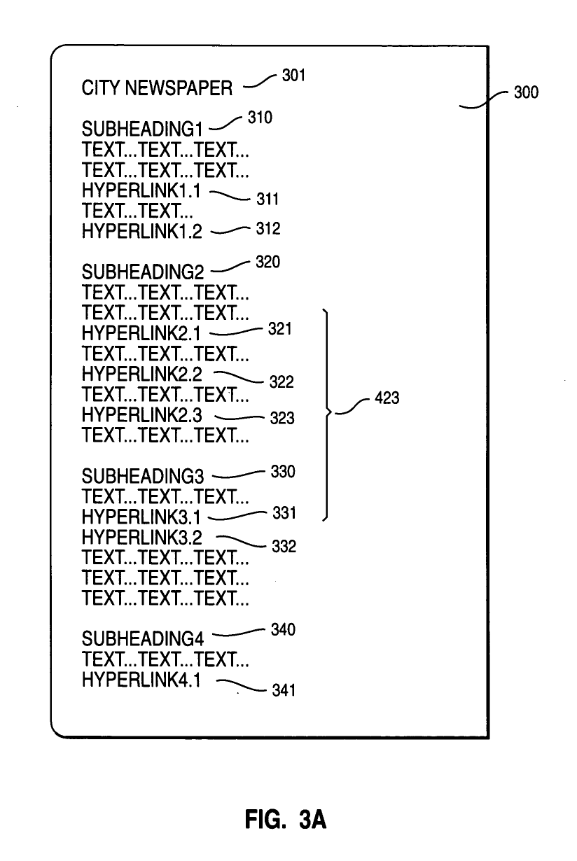

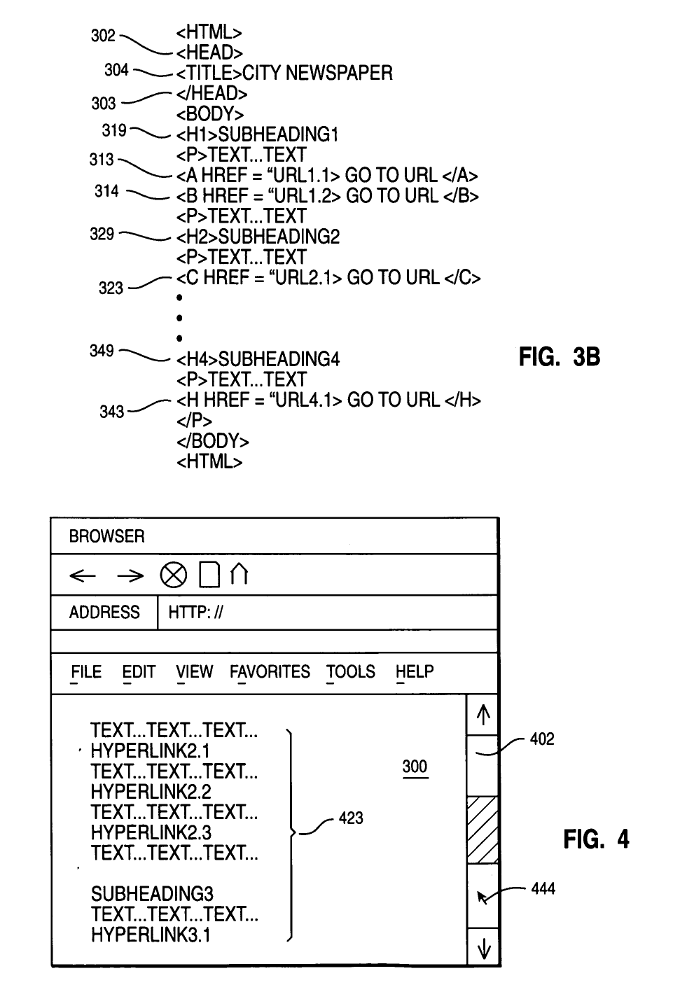

FIG. 3A illustrates a long document 300 having the following document components: headings 301, subheadings 310, 320, 330, 340, and hyperlinks 311, 312, 321, 322, 323, 331, 332, 341. The document 300 may reside at a server and be retrieved by a browser running on a client using a URL associated with the document 300. FIG. 3B illustrates the Hypertext Markup Language (HTML) which the browser interprets to display the long document of FIG. 3A. In a preferred embodiment of the invention, the browser further parses the HTML document for tags specifying the document components, e.g., title, subheadings, hyperlinks, images, etc., such as the <title> tag 304, subheading tags 319, 329, 349, and hyperlink tags 313, 314, 323, 343, as further discussed below.

FIG. 4 illustrates the rendering of the long document 300 by a browser at a client. Since the viewable screen areas vary in size for different client devices (such as displays on hand held devices and displays in association with desk top environments) the long document as shown in FIG. 3A may not be able to be completely displayed within the viewable screen display on a given client device. As such, as shown in FIG. 4, the browser displays a portion 423 of the long document 300 in conjunction with a scroll bar 402.

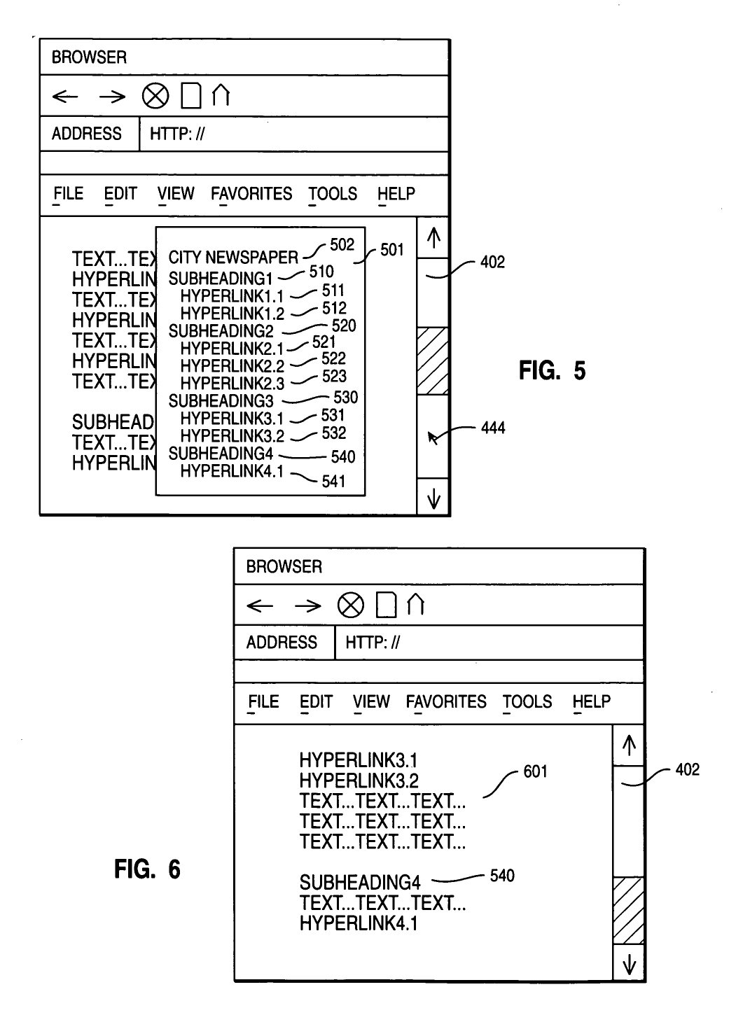

In response to a designated user action, such as a right mouse click while the mouse pointer 444 is located within the scroll bar 402 (FIG. 4), the browser displays a list 501 (FIG. 5) of the long document 300 (FIG. 3A) comprising heading 502, subheadings 510, 520, 530, 540 and/or hyperlinks 511, 512, 521, 522, 523, 531, 532, 541. It should be noted that if the list itself becomes too long to be displayed within the viewable screen area, then a scroll bar would be displayed in conjunction with the list.

If the user makes a user action outside of the list, then the list would no longer be displayed over the currently displayed portion of the long document. If the user makes a selection within the displayed list, then the browser would display that portion of the document containing the selected document component. When that portion of the document is displayed, the list would no longer be displayed until a next designated user action is received that then causes the list to be displayed.

If the user selected subheading4, 540 (FIG. 5), then, as shown in FIG. 6, the portion 601 of the long document 300 containing the selected subheading 540, i.e., the end of the document in this example, would be displayed. As such, a user is able to go directly to a desired location within a long document without having to wait as other content not of interest scrolls across the display.

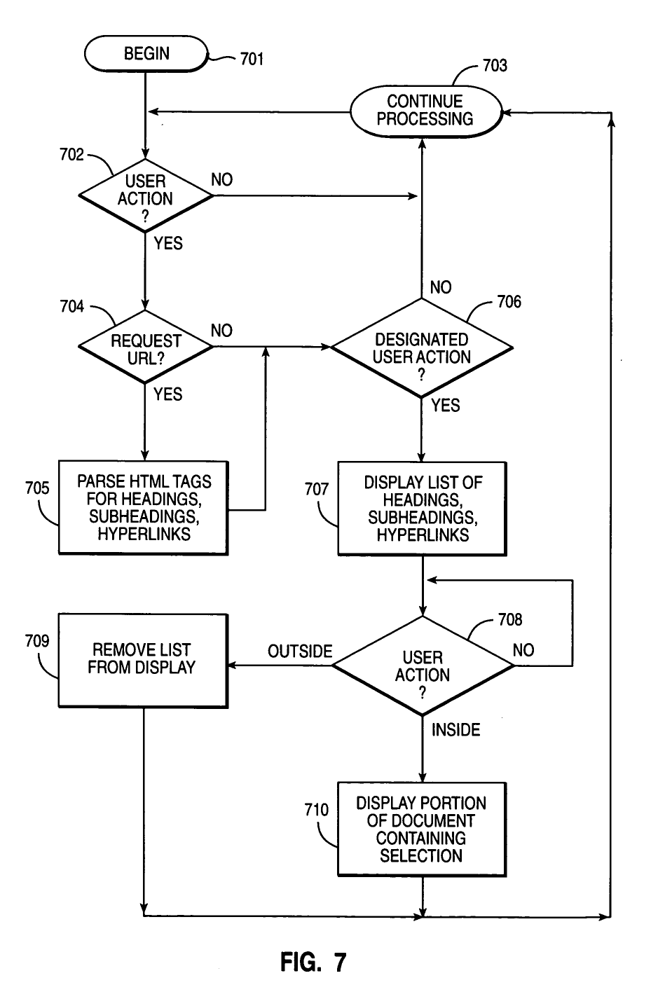

FIG. 7 illustrates a process and program flow for parsing a document for the document components of a Web page including the heading, subheadings and hyperlinks; rendering a list of the parsed portions in response to a single user action; and automatically displaying a desired portion of the document in response to a selection of a document component within the list. More specifically, the process begins at step 701 and continues to step 702 for determining whether there is a user action. If there is no user action, the processing continues 703 until a user action is detected. If there is a user action, a determination is made if the user action is a URL request for a document, 704. If it is such a request, then the document is requested and received. Upon receiving the document, the document is parsed for the HTML tags for any headings, subheadings, or hyperlinks, 705. Either after the parsing, or after a determination that the user action was not a URL request, there is a determination as to whether or not a designated user action is being received, 706. For example, a designated user action may be a right mouse click in the scroll bar area or other designated action that causes a list of document components in the document to be displayed. If the user action is not the designated user action, then processing continues as shown at step 703. If the user action is the designated user action, then a list of the parsed headings, subheadings, and/or hyperlinks are displayed, 707. Then there is a determination of whether or not a user action is received, 708. If a user action is not received, the process continues until a user action is received. If a user action is received, then it is determined whether the user action is a selection outside of the list area or within the list area. If the user action involves an area outside of the displayed list area, then the displayed list is no longer displayed, 709. The current displayed portion of the long document continues to be displayed. If the user action involves an area within the displayed list area, such as a selection of one of the displayed headings, subheadings, or hyperlinks, the list is no longer displayed and the portion of the document containing the selected item is displayed, 710. Processing then continues, 703.

As such, upon a designated user action, such as a right mouse click within a scroll bar area, a list of document components of a Web document are displayed to a user. A selection of a document component within the list displays the portion of the long document containing the selected document component. The displayed list is independent from the displayed scroll bars. That is, the list is a separately displayed frame or window and not associated with the scroll bars. There is no mapping between the size of the scroll bars or the long document and the size of the list. The list does not have to maintain any relationship in size to the overall size of the underlying long document or to any relative relationship among the various document components. In a preferred embodiment, the list of at least some types of components are displayed alphabetically and not necessarily in a form or order that reflects the position of the document component in the underlying document. For example, although all headings may be listed alphabetically, each image or hyperlink occurring under that heading in the underlying long document may still be displayed in the list under that heading. Any document component within the list, i.e., any heading, hyperlink, etc. can be selected. The displayed document will then “jump” to that portion of the document containing the selected component.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as CD-ROMs, DVDs, read only memories (ROMs) or erasable, electrically programmable read only memories (EEPROMs), recordable type mediums such as floppy disks, hard disk drives and CD-RW and DVD-RW disks, and transmission type mediums such as digital and analog communication links, or any signal bearing media. As such, the functionality of the above described embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

The foregoing description of the preferred embodiments of the invention has been presented for the purposes of illustration and description. It is not intended to be exhaustive or to limit the invention to the precise form disclosed. Many modifications and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for displaying portions of a long document in a limited viewing area of a display on a client machine, comprising:
retrieving a requested long document from a server communicatively connected over a network to the client;
parsing the document for tags identifying headings;
displaying a portion of the document in conjunction with a scroll bar;
in response to receiving a designated user action, displaying a list of identified headings from the parsed tags; and
in response to receiving a user selection of one of the identified headings within the list, displaying another portion of the document containing the selected identified heading.

2. The method of claim 1 wherein parsing the document for tags identifying headings further comprises parsing the document for tags identifying hyperlinks; and wherein displaying a list of identified headings further comprises displaying identified hyperlinks in a visual association with the displayed headings; and further comprising displaying another portion of the document containing a selected identified hyperlink in response to receiving a different user selection of one of the identified hyperlinks.

3. The method of claim 1 wherein the designated user action is a right mouse click within the scroll bar area.

4. The method of claim 1 wherein the identified headings are displayed in an alphabetical order.

5. The method of claim 1 further comprising removing the list from being displayed if a subsequent user action outside of the displayed list area is received.

6. A computer system having a limited viewing area display for displaying portions of a long document, comprising:
a browser application having means for retrieving a requested long document from a server communicatively connected over a network;
means for parsing the document for tags identifying headings;
means for displaying a portion of the document in conjunction with a scroll bar;
in response to receiving a designated user action, means for displaying a list of identified headings from the parsed tags; and
in response to receiving a user selection of one of the identified headings within the list, means for displaying another portion of the document containing the selected identified heading.

7. The system of claim 6 wherein the means for parsing the document for tags identifying headings further comprises means for parsing the document for tags identifying hyperlinks; and wherein the means for displaying a list of identified headings further comprises means for displaying identified hyperlinks in a visual association with the displayed headings; and further comprising means for displaying another portion of the document containing a selected identified hyperlink in response to receiving a different user selection of one of the identified hyperlinks.

8. A computer program having computer readable program code means on a computer usable medium, comprising:
instruction means for parsing a document received over a network for tags identifying headings;
instruction means for displaying a portion of the document in conjunction with a scroll bar;
in response to receiving a designated user action, instruction means for displaying a list of identified headings from the parsed tags; and
in response to receiving a user selection of one of the identified headings within the list, instruction means for displaying another portion of the document containing the selected identified heading.

9. The computer program of claim 8 wherein the means for parsing the document for tags identifying headings further comprises means for parsing the document for tags identifying hyperlinks; and wherein the means for displaying a list of identified headings further comprises means for displaying identified hyperlinks in a visual association with the displayed headings; and further comprising means for displaying another portion of the document containing a selected identified hyperlink in response to receiving a different user selection of one of the identified hyperlinks.
